(19) United States
(12) Patent Application Publication
(10) Pub. No.: US 2020/0134116 A1
(43) Pub. Date: Apr. 30, 2020

(54) SIMULATION SYSTEM AND METHOD

(71) Applicant: Industrial Technology Research Institute, Hsinchu (TW)

(72) Inventors: Yeong-Jar CHANG, Taichung County (TW); Jen-Hsiang LEE, New Taipei City (TW); Liang-Ying LU, Changhua County (TW)

(21) Appl. No.: 16/226,501

(22) Filed: Dec. 19, 2018

(30) Foreign Application Priority Data
Oct. 31, 2018 (TW) 107138489

(51) Int. Cl. G06F 17/50

(52) U.S. Cl. CPC G06F 17/5036; G06F 2217/86; G06F 2217/78; G06F 17/5022

(57) ABSTRACT

A simulation system includes an application, a chip model and an off-chip model. The application is configured to generate a corresponding instruction set in accordance with an application situation of a simulation circuit, wherein the simulation circuit includes a chip. The chip model receives the instruction set as an input to simulate operation of at least one intellectual property core of the chip via high-level languages in accordance with the at least one intellectual property core of the chip and to generate a power consumption and an I/O logic signal of the chip. The off-chip model constructs one or more orders of RLCG circuit cascading models in accordance with all or part of the off-chip model abstracted by the S parameter. The application program and the RLCG circuit cascading model are integrated for simulating and analyzing power integrity and signal integrity of the simulation system.

### CROSS REFERENCE TO RELATED APPLICATIONS

This application claims priority of and the benefit of Taiwan Application No. 107138489, filed Oct. 31, 2018.

### TECHNICAL FIELD

The present disclosure relates to a simulation system and method.

### BACKGROUND

As the complexity of chip system design increases, the product development time required for a traditional Register-Transfer Level (RTL) design process is getting longer. Current chip system designs require a high degree of integration of hardware and software, so that the time for software development is essential to whole product development cycle. However, the traditional RTL design process cannot provide a software simulation environment in the early stages of hardware design. Therefore, it is an inevitable trend to shorten the development time of system software and hardware by using Electronic System-Level (ESL) design.

Most of the current practice-level technologies can simulate performance and power consumption, and a few techniques can simulate temperature, but no techniques have been found that can simulate electrical properties. On the one hand, electrical-simulation engineering continues to pursue high-frequency models and accuracy, but it has never thought of sacrificing accuracy in exchange for accelerated simulation effects. On the other hand, the system-level simulation technology of heterogeneous integration is in the enlightenment stage, and there is not much research invested.

Recently, the rise of high-end applications such as the Internet of Things, handheld systems, automotive electronics, high-speed computing and AI chips is increasingly requiring high computational or highly system-integrated designs. In addition to considering performance, power consumption and temperature, heterogeneous integration is becoming more and more important. The traditional method can analyze the simulation in the middle and late orders of design, and often consumes a lot of unnecessary manpower and material resources. Therefore, the ability to upgrade heterogeneous electrical analysis to the electronic system level is a manifestation of competitiveness and a future trend.

### SUMMARY

An embodiment of the present disclosure discloses a simulation system, comprising an application program, configured to generate a corresponding instruction set in accordance with an application situation of a simulation circuit; wherein the simulation circuit comprises a chip; a chip model, configured to receive the instruction set as an input to simulate operation of at least one intellectual property core of the chip via high-level languages in accordance with the intellectual property core of the chip and to generate a power consumption and an I/O logic signal of the chip; and an off-chip model, configured to construct one or more orders of RLCG (resistor-inductor-capacitor-conductor) circuit cascading models in accordance with all or part of the off-chip model abstracted by the S parameter. The application program and the RLCG circuit cascading model are integrated for simulating and analyzing power integrity and signal integrity of the simulation circuit.

The present disclosure also discloses a simulation method, implementing an application program to generate a corresponding instruction set in accordance with an application situation of a simulation circuit, wherein the simulation circuit comprises a chip, comprises generating a chip model configured to receive the instruction set as an input to simulate operation of at least one intellectual property core of the chip via high-level languages in accordance with the intellectual property core of the chip and to generate a power consumption and an I/O logic signal of the chip; generating an off-chip model configured to construct one or more orders of RLCG (resistor-inductor-capacitor-conductor) circuit cascading models in accordance with all or part of the off-chip model abstracted by the S parameter; and integrating the application program and the RLCG circuit cascading model for simulating and analyzing power integrity and signal integrity of the simulation circuit.

### BRIEF DESCRIPTION OF THE DRAWINGS

FIG. 1 is a block diagram of a simulation system 100 in accordance with an embodiment of the disclosure.

FIG. 2 is an impedance-frequency response diagram of all or part of the off-chip model 108 abstracted by the S parameter in accordance with the embodiment of the disclosure.

FIG. 3 is a schematic diagram of a double orders RLCG circuit cascading model in accordance with the embodiment of the disclosure.

FIG. 4 is a schematic diagram of the impedance difference between all or part of the off-chip model 108 abstracted by the S parameter in FIG. 2 and a first circuit model 300 in FIG. 3 in accordance with the embodiment of the disclosure.

FIG. 5 is a flow chart of constructing one or more orders of RLCG circuit cascading models in accordance with the embodiment of the disclosure;

FIG. 6 is an impedance-frequency response diagram of constructing one or more orders of RLCG circuit cascading models in accordance with the embodiment of the disclosure.

### DETAILED DESCRIPTION OF THE DISCLOSURE

The present disclosure can be more fully understood by reading the subsequent detailed description with references made to the accompanying figures.

It should be understood that the figures are not drawn to scale in accordance with standard practice in the industry. In fact, it is allowed to arbitrarily enlarge or reduce the size of devices for clear illustration.

The present disclosure provides a simulation system and method, so that an electrical simulation of the system level can be achieved, and the software, the chip, the package and the PCB can be integrated together for electrical simulation.

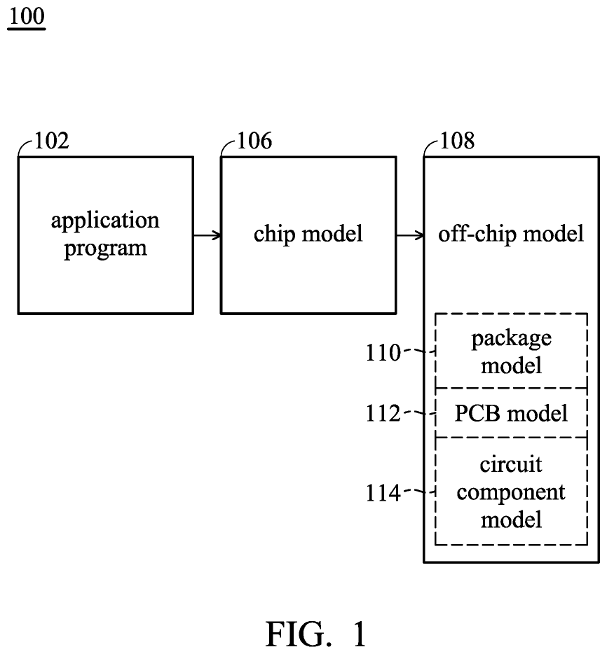

FIG. 1 is a block diagram of a simulation system 100 in accordance with an embodiment of the disclosure. As shown in FIG. 1, simulation system 100 includes an application program 102, a chip model 106, and an off-chip model 108. The application program 102, when executed by a processor or an electronic device, generates a corresponding instruction set in accordance with an application situation of a simulation circuit (or a target circuit to be simulated), wherein the simulation circuit comprises a chip. The application program 102 can be an application program applied on a smartphone, a smart wearable device, a personal computer, a laptop, or a server, but is not limited thereto. For example, if a user would like to know power consumption or I/O logic signal from a chip in the smartphone while running a game, the application program 102 transfers the application situation (the game running situation) to the instruction set of the chip in the smartphone, the instruction set can be an input signal of the chip model 106 for triggering the whole simulation environment. That is, the simulation environment for the chip in the smartphone running the game, which includes some algorithms or software scheduling, etc. In the present embodiment, the application program 102 is accomplished by QEMU (quick emulator), but the present disclosure is not limited thereto.

The chip model 106 receives the instruction set from the application program 102 as an input to simulate operation of at least one intellectual property core of the chip via high-level languages in accordance with the intellectual property core of the chip and to generate a power consumption and an I/O logic signal of the chip. For example, when the smartphone is running a game, after simulating a complex computation of the chip in the smartphone, the chip model 106 generates the power consumption and the I/O logic signal of the chip. For the off-chip model 108, S parameter is used in the prior art to describe all or part of the off-chip model 108. However, the present disclosure abstracts the S parameter to construct one or more orders of RLCG (resistor-inductor-capacitor-conductor) circuit cascading models to replace the complex S parameter, so that the one or more orders of RLCG circuit cascading models can be simulated using high-level languages. The present disclosure can be used for chip-package-PCB integration simulation by simply integrating with software at the beginning of design, and does not require complex software like HSPICE to finish analyzing power integrity (PI) and signal integrity (SI) quickly. Wherein all or part of the off-chip model 108 abstracted by the S parameter is obtained by extracting all or part of the chips of the simulation system (for example, a smartphone) using an electronic design automation (EDA) tool. The application program 102, the instruction set, the chip model 106, and the off-chip model 108 are accomplished using high-level languages. In the present embodiments, the application program 102 is accomplished by QEMU, the chip model 106 is accomplished by SystemC, and the off-chip model is accomplished by SystemC-AMS. For example, the chip model 106 may be implemented by a chip simulator or a processor which executes codes of high-level language and is configured to simulate functions of the chip defined by the intellectual property core. Similarly, the off-chip model 108 may be implemented by a processor or some hardware which executes high-level language in conjunction with the extracted S parameter to construct the RLCG (resistor-inductor-capacitor-conductor) circuit model.

Commonly used EDA tools include HFSS, SIwave, Q3D, PowerSI, ExtractIM and ADS could generate the S-parameter models by extracting the models of package, PCB or components. For example, when the system is integrated, the power goes from a regulator, through components, layouts, layers, and packages, finally to the intellectual property core of the chip, and may have some loss. The extent of this loss can be described by power impedance, and the commercial software is used to model the physical design of the world outside the chip by using the electromagnetic software, which is scattering parameters (S parameters).

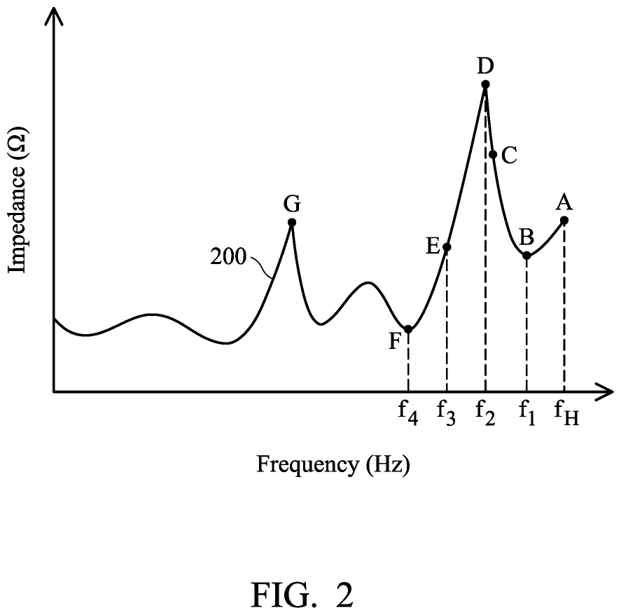

FIG. 2 is an impedance-frequency response diagram of all or part of the off-chip model 108 abstracted by the S parameter in accordance with the embodiment of the disclosure. For example, the off-chip model 108 is the scattering parameter (S parameter) abstracted from the commercial software described above, including the S parameter from package model 110, PCB model 112, circuit component model 114 or the combination model thereof (but the present disclosure is not limited to), and is transferred to an impedance-frequency response 200 (Z parameter) of all or part of the off-chip model 108 abstracted by the S parameter to construct one or more RLCG circuit cascading model.

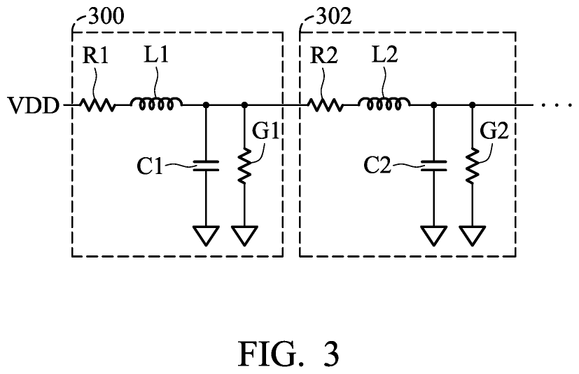

The off-chip model 108 searches for at least one resonant frequency in accordance with the impedance-frequency response 200 of all or part of the off-chip model 108 abstracted by the S parameter. FIG. 3 is a schematic diagram of a double orders RLCG circuit cascading model in accordance with the embodiment of the disclosure. As shown in FIG. 3, assuming that the effects of the second circuit model 302 and the conductance G1 are not considered, the following relationship can be obtained.

$$Z ( ω ) = ( {R}_{1} + j ω {L}_{1} ) \vert \vert {C}_{1} = \frac{1}{\frac{1}{{R}_{1} + j ω {L}_{1}} + j ω {C}_{1}} = \frac{{R}_{1} + j ω {L}_{1}}{1 + j ω {R}_{1} {C}_{1} - {ω}^{2} {L}_{1} {C}_{1}} \\ \vert Z ( ω ) \vert = \sqrt{\frac{{R}_{1}^{2} + {( ω {L}_{1} )}^{2}}{{( ω {R}_{1} {C}_{1} )}^{2} + {( 1 - {ω}^{2} {L}_{1} {C}_{1} )}^{2}}} \qquad equation 1$$

According to the equation 1, when R₁=0, G₁=0 and ω²=1/L₁C₁, the impedance Z(ω) has a maximum value. In more detail, the original impedance series and parallel calculations have real and imaginary parts, so the calculation is complicated, but since the frequency is constant, and the power impedance calculated by the present disclosure is also a real value, the above calculation becomes very simple. Therefore, the impedance calculation of the present disclosure is fast. The equation 1 above is used to evaluate a difference between the abstract model constructed by the present disclosure and the power impedance converted by the scattering model (S parameter) extracted by the original commercial software. Meanwhile, the equation 1 can be used to adjust the value of RLCG (that is, one or more orders of RLCG circuit cascading models) parameter.

As shown in FIG. 2, the off-chip model 108 first searches a frequency point with maximum impedance from a point A of highest frequency f_{H}, and a point B is found. The impedance of the point B is smaller than that of the point A. The off-chip model 108 determines that if frequency f₁ of the point B is smaller than one tenth of frequency f_{H} of the point A, that is f₁<f_{H}/10, and the impedances of the frequency points above f_{H}/10 are smaller than that of the frequency f_{H}, then the point A is determined to be the frequency point with the highest impedance nearby, and the point A is set to a resonance frequency point. If frequency f₁ of the point B is larger than one tenth of frequency f_{H} of the point A, that is f₁>f_{H}/10, then the off-chip model 108 keeps searching for the frequency point with maximum impedance along to the low frequency direction. In FIG. 2, since the frequency f₁ of the point B is larger than one tenth of frequency f_{H} of the point A, the off-chip model 108 keeps searching along to the low frequency direction to find point C. The impedance of the point C is larger than that of the point B, thus the off-chip model 108 sets the point C as an initial point for searching resonant frequency, and keeps searching along to the low frequency to find point D. The impedance of the point D is larger than that of the point C, thus the off-chip model 108 sets the point D as an initial point for searching resonant frequency again, and keeps searching along to the low frequency to find point E. in FIG. 2, the impedance of the point E is larger than that of the point D, and the frequency f₃ of the point E is smaller than one tenth of the frequency f₂ of the point D, that is f₃<f₂/10, and the impedances of the frequency points above f₂/10 are smaller than that of the frequency f₂, then the off-chip model 108 defines the frequency f₂ of the point D as a first resonant frequency fₘₐₓ₁ with maximum impedance.

Then, the off-chip model 108 sets the point D as an initial point for searching resonant frequency again, and keeps searching along to the low frequency to find point F. The impedance of the point E is smaller than that of the point D, and when the impedances between one tenth of frequency f₄ of the point F and the frequency fₘₐₓ₁ of the point D are all smaller than that of the point D, the off-chip model 108 sets the frequency f₄ of the point F as a first minimum impedance frequency fₘᵢₙ₁. According to the searching method of the impedance-frequency response 200 of all or part of the off-chip model 108 abstracted by the S parameter in FIG. 2, the corresponding resonant frequency, such as fₘₐₓ₁, fₘₐₓ₂, . . . , fₘₐₓₙ, and at least one minimum impedance frequency, such as fₘᵢₙ₁, fₘᵢₙ₂, . . . , fₘᵢₙₙ, can be found in the impedance-frequency response 200 of all or part of the off-chip model 108 abstracted by the S parameter. Thus, the off-chip model 108 can adjust the values of the capacitor (C) and the inductors (L) corresponding to at least one circuit model in accordance with the resonant frequency. It should be noted that the determination criteria of the resonant frequency can be adjusted in accordance with the calculation requirement, for example, the original criteria f₃<f₂/10 can be changed to f₃<f₂/5.

For example, if two resonance frequency points (such as point C and point D in FIG. 2) are found in the impedance-frequency response 200 of all or part of the off-chip model 108 abstracted by the S parameter, the off-chip model 108 needs to generate two orders of the circuit model (the quantity of the resonance frequency point and the order of the circuit model are merely examples, and are not limiting as the present disclosure), as shown in FIG. 3, that is a first circuit model 300 and a second circuit model 302 arranged in sequence. The first circuit model 300 corresponds to the first resonance frequency point D in FIG. 2, and the second circuit model 302 corresponds to the second resonance frequency point G in FIG. 2. The off-chip model 108 needs to find an inductance L₁ in the first circuit model 300 at the first resonance frequency point D, so that the impedance difference between the first circuit model 300 (Zₑₛₜ₁) and the impedance-frequency response 200 of all or part of the off-chip model 108 abstracted by the S parameter (Z_{target}) is at a minimum. That is, the error ΔZ₁=|Z_{target}−Zₑₛₜ₁| is at a minimum. Similarly, the off-chip model 108 needs to find an inductance L₂ in the second circuit model 302 at the second resonance frequency point G, so that the impedance difference between the second circuit model 302 (Zₑₛₜ₂) and the impedance-frequency response 200 of all or part of the off-chip model 108 abstracted by the S parameter (Z_{target}) is at a minimum. That is, the error ΔZ₂=|Z_{target}−Zₑₛₜ₂| is at a minimum.

The off-chip model 108 first sets the value of the resistors and the conductors in the first circuit model 300 and the second circuit model 302 as 0 (that is, R₁, G₁, R₂, G₂). Then, at the frequency of one-tenth of the frequency fₘₐₓ₁ of the first resonance frequency point D in FIG. 2, the frequency=fₘₐₓ₁/10=f₂/10, that is the point E in FIG. 2 (if f₃=f₂/10), the off-chip model 108 reads the impedance of the point E. During the frequency band from the point E to the first resonance frequency point D, the corresponding impedance value becomes larger as the frequency increases. In other words, the inductance value almost determines the impedance at these frequencies. Therefore, according to impedance R and frequency f₃=ω₃ corresponding to the point E, the initial inductance value Lₑₛₜ may be obtained using the following equation.

$$R = \vert j {ω}_{3} {L}_{est} \vert = {ω}_{3} {L}_{est} \\ {L}_{est} = \frac{R}{{ω}_{3}} \qquad equation 2$$

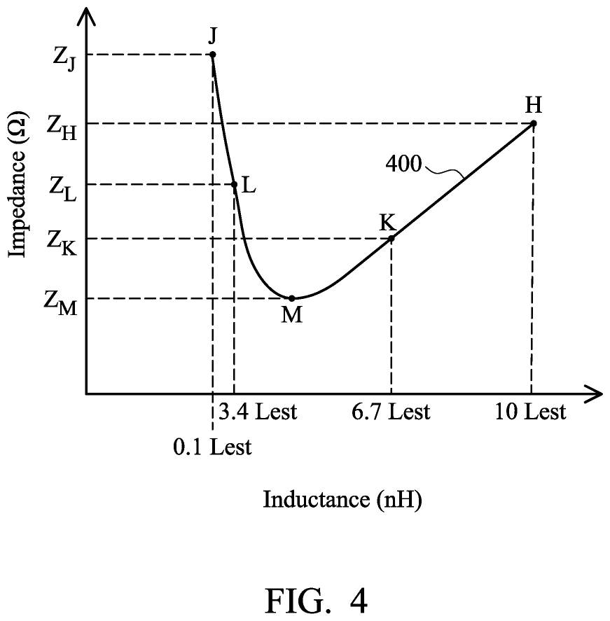

FIG. 4 is a schematic diagram of the impedance difference between all or part of the off-chip model 108 abstracted by the S parameter in FIG. 2 and a first circuit model 300 in FIG. 3 in accordance with the embodiment of the disclosure.

Impedance error 400 is the impedance difference between the first circuit model 300 and the impedance-frequency response 200 of all or part of the off-chip model 108 abstracted by the S parameter at the first resonance frequency point D (the frequency=fₘₐₓ₁), that is the impedance error 400=ΔZ₁=|Z_{target}−Zₑₛₜ₁|. As shown in FIG. 4, the off-chip model 108 changes the inductance value in the range between 10*Lₑₛₜ and 0.1*Lₑₛₜ to find a specific inductance value by a tri-search method (but not limited to), so that impedance errors 400 can kept to a minimum. The point H has an impedance difference Z_{H} that corresponds to the inductance value 10*Lₑₛₜ, and the point H is the right initial point for the tri-search method. The point J has an impedance difference Z_{J} that corresponds to the inductance value 0.1*Lₑₛₜ, and the point J is the left initial point for the tri-search method. The point L has an impedance difference Z_{L} that corresponds to the inductance value 3.4*Lₑₛₜ (from (⅔)*(0.1*Lₑₛₜ)+(⅓)*(10*Lₑₛₜ)). The point K has an impedance difference Z_{K} that corresponds to the inductance value 6.7*Lₑₛₜ (from (⅓)*(0.1*Lₑₛₜ)+(⅔)*(10*Lₑₛₜ)). The point M has an impedance difference Z_{M}. According to the tri-search method, if Z_{J}>Z_{L} and Z_{L}>Z_{K}, then the point L is set as a new left initial point. If Z_{J}≤Z_{L} and Z_{L}≤Z_{K}, then the point K is set as a new right initial point. According to the above method, a convergence of the inductance range is performed, and finally the point M can be found. The specific inductance value corresponding to the point M can ensure that impedance errors 400 are kept to a minimum. That is, Z_{M}. After finding the specific inductance value, because the frequency fₘₐₓ₁ of the first resonance frequency point D is fixed, the capacitance value corresponding to the specific inductance value can also be found, and finally the value of L₁ and C₁ from the first circuit model 300 can be obtained.

Similarly, by using the tri-search method, the off-chip model 108 keeps searching for the second resonance frequency point G in FIG. 2, and finds another specific inductance value for the inductor L₂ in the second circuit model 302, so that the impedance difference between the impedance of the second circuit model 302 (Zₑₛₜ₂) and the impedance-frequency response 200 of all or part of the off-chip model 108 abstracted by the S parameter (Z_{target}) is at a minimum. The value of L₂ and C₂ from the second circuit model 302 can be obtained in accordance with another specific inductance.

After adjusting the values of L₁, C₁, L₂ and C₂, in the frequency points between the first resonance frequency point D and the second resonance frequency point G in FIG. 2, there is an impedance offset error between the impedance of the first circuit model 300 (Zₑₛₜ₁) or the second circuit model 302 (Zₑₛₜ₂) and the impedance of the impedance-frequency response 200 of all or part of the off-chip model 108 abstracted by the S parameter (Z_{target}). Therefore, by simultaneously or separately adjusting R₁ of the first circuit model 300 or R₂ of the second circuit model 302, the values of Zₑₛₜ₁ and Zₑₛₜ₂ are increased, or by simultaneously or separately adjusting G₁ of the first circuit model 300 or G₂ of the second circuit model 302, the value of Zₑₛₜ₁ and Zₑₛₜ₂ are decreased, so that Zₑₛₜ₁ and/or Zₑₛₜ₂ have the smallest impedance difference with Z_{target}. The method of adjusting the values of R₁, G₁, R₂, and G₂ can also use the tri-search method. The tri-search method has been described in the paragraphs [0022] to [0027], and FIG. 4, and therefore will not be described again.

After adjusting the first circuit model 300 and the second circuit model 302, the RLCG circuit cascading model (such as the first circuit model 300 and the second circuit model 302) and the chip model 106 are integrated, comprising compiling the RLCG cascading model from SystemC-AMS to a first code, compiling the chip model 106 from SystemC to a second code, cascading the first code and the second code and inputting a signal generated by the application program 102, and after calculating, so that the RLCG circuit cascading model can receive the power consumption and the I/O logic signal generated by the simulation system.

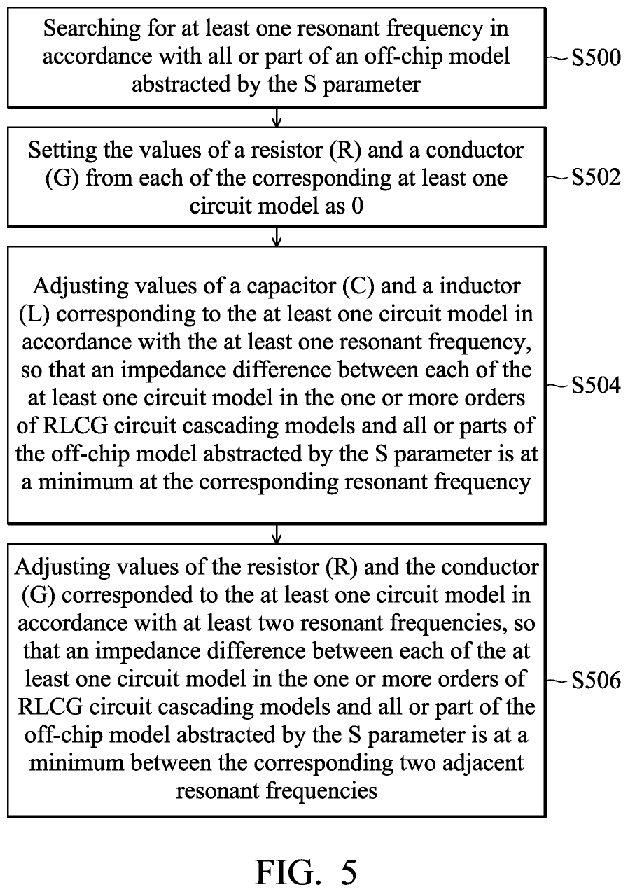

FIG. 5 is a flow chart of constructing one or more orders of RLCG circuit cascading models in accordance with the embodiment of the disclosure. As shown in FIG. 5, the off-chip model 108 searches for at least one resonant frequency in accordance with the impedance-frequency response of all or part of the off-chip model 108 abstracted by the S parameter (step S500), sets the values of the resistor (R) and the conductor (G) from each of the corresponding circuit model (such as the first circuit model 300 and the second circuit model 302 in FIG. 3) as 0 (step S502), adjusts the values of the capacitor (C) and the inductors (L) corresponding to the circuit model in accordance with the resonant frequency, so that the impedance difference between each of the circuit models in the orders of RLCG circuit cascading models and the impedance-frequency response 200 of all or part of the off-chip model 108 abstracted by the S parameter is at a minimum at the corresponding resonant frequency (step S504), and adjusts the values of the resistor and the conductor that correspond to at least one circuit model in accordance with at least two resonant frequencies, so that the impedance difference between each of the circuit models in the orders of RLCG circuit cascading models and the impedance-frequency response 200 of all or part of the off-chip model 108 abstracted by the S parameter is at a minimum between the two corresponding adjacent resonant frequencies (step S506). The details of the steps S500 to S506 have been described in the paragraphs [0019] to [0030], and therefore will not be described again.

According to the simulation system disclosed above, the off-chip model is configured to construct one or more orders of RLCG circuit cascading models, comprising searching for at least one resonant frequency in accordance with all or part of the off-chip model abstracted by the S parameter; and adjusting the values of the capacitor and the inductors corresponding to at least one circuit model in accordance with the resonant frequency, so that the impedance difference between each of the circuit models in the orders of RLCG circuit cascading models and all or part of the off-chip model abstracted by the S parameter is at a minimum at the corresponding resonant frequency.

According to the simulation system disclosed above, the off-chip model is configured to construct one or more orders of RLCG circuit cascading models, further comprising: adjusting the values of the resistor and the conductor that correspond to at least one circuit model in accordance with at least two resonant frequencies, so that the impedance difference between each of the circuit models in the orders of RLCG circuit cascading models and all or part of the off-chip model abstracted by the S parameter is at a minimum between the two corresponding adjacent resonant frequencies.

According to the simulation system disclosed above, the application program and the RLCG circuit cascading model, which are integrated, comprise: compiling the RLCG cascading model from SystemC-AMS to a first code; compiling the chip model from SystemC to a second code; cascading the first code and the second code and inputting a signal generated by the application program; and after calculating, the RLCG circuit cascading model can receive the power consumption and the I/O logic signal generated by the simulation system.

According to the simulation system disclosed above, the power consumption of the chip generated by the chip model is used for analyzing power integrity, and the I/O logic signal of the chip is used for analyzing signal integrity.

According to the simulation system disclosed above, the off-chip model is configured to construct one or more orders of RLCG circuit cascading models for abstracting all or part of the off-chip model to replace the S parameter.

According to the simulation system disclosed above, the application program, the instruction set, the chip model, and the off-chip model can be accomplished using high-level languages.

According to the simulation method disclosed above, the off-chip model is configured to construct one or more orders of RLCG circuit cascading models, comprising: searching for at least one resonant frequency in accordance with all or part of the off-chip model abstracted by the S parameter; adjusting the values of the capacitor and the inductors that correspond to at least one circuit model in accordance with the resonant frequency, so that the impedance difference between each of the circuit models in the orders of RLCG circuit cascading models and all or part of the off-chip model abstracted by the S parameter is at a minimum at the corresponding resonant frequency.

According to the simulation method disclosed above, the off-chip model is configured to construct one or more orders of RLCG circuit cascading models, the method further comprising: adjusting the values of the resistor and the conductor that correspond to at least one circuit model in accordance with at least two resonant frequencies, so that the impedance difference between each of the circuit models in the orders of RLCG circuit cascading models and all or part of the off-chip model abstracted by the S parameter is at a minimum between the two corresponding adjacent resonant frequencies.

According to the simulation method disclosed above, the application program and the RLCG circuit cascading model are integrated, the method comprising: compiling the RLCG cascading model from SystemC-AMS to a first code; compiling the chip model from SystemC to a second code; cascading the first code and the second code and inputting a signal generated by the application program; and after calculating, the RLCG circuit cascading model can receive the power consumption and the I/O logic signal generated by the simulation system.

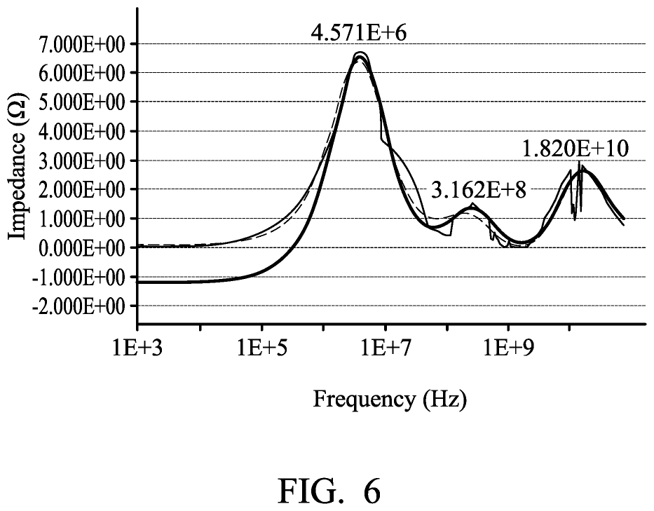

According to the simulation method disclosed above, the power consumption of the chip generated by the chip mode is used for analyzing power integrity, and the I/O logic signal of the chip is used for analyzing signal integrity. At the beginning of the design of the chip model, if there is no detailed physical design, the design experience can be used to produce the best, typical and worst cases. The chip model is verified in the frequency domain and the time domain to accelerate the power integrity simulation by more than two orders and maintain high accuracy. One or more orders of RLCG circuit cascading models constructed by the off-chip model have the greatest similarity to all or part of the given off-chip model abstracted by the S parameter. That is, the impedance error between the one or more orders of RLCG circuit cascading models and all or part of the off-chip model abstracted by the S parameter is at a minimum. For example, FIG. 6 is an impedance-frequency response diagram of constructing one or more orders of RLCG circuit cascading models in accordance with the embodiment of the disclosure. As shown in FIG. 6, the “thin line” is an impedance-frequency response of all or part of the given off-chip model abstracted by the S parameter. The “thick line” is the impedance-frequency response of three orders of RLCG circuit cascading model constructed by the off-chip model, wherein the values of R and G are not adjusted yet. The “dotted line” is the impedance-frequency response of three orders of RLCG circuit cascading model constructed by the off-chip model, and the values of R and G have been adjusted. The average impedance error rate between the “thick line” and the “thin line” is about 7.09%, and the average impedance error rate between the “dotted line” and the “thin line” is 4.54%. In other words, the impedance error between the three orders of RLCG circuit cascading model represented by the “dotted line” and all or part of the given off-chip model abstracted by the S parameter represented by the “thin line” is at a minimum.

According to the simulation method disclosed above, the off-chip model is configured to construct one or more orders of RLCG circuit cascading models for abstracting all or part of the off-chip model to replace the S parameter.

According to the simulation method disclosed above, the application program, the instruction set, the chip model, and the off-chip model can be accomplished using high-level languages.

The ordinal in the specification and the claims of the present disclosure, such as “first”, “second”, “third”, etc., has no sequential relationship, and is just for distinguishing between two different devices with the same name. In the specification of the present disclosure, the word “couple” refers to any kind of direct or indirect electronic connection. The present disclosure is disclosed in the preferred embodiments as described above, however, the breadth and scope of the present disclosure should not be limited by any of the embodiments described above. For example, the method flow chart in FIG. 5 is implemented in a designated sequence, but persons skilled in the art can make small changes (such as changing or combining the steps illustrated in FIG. 5) and retouches without departing from the spirit and scope of the present disclosure. The scope of the present disclosure should be defined in accordance with the following claims and their equivalents.

What is claimed is:

1. A simulation system, comprising:
an application program, configured to generate a corresponding instruction set in accordance with an application situation of a simulation circuit; wherein the simulation circuit comprises a chip;
a chip model, configured to receive the instruction set as an input to simulate operation of at least one intellectual property core of the chip in accordance with the at least one intellectual property core of the chip and to generate a power consumption and an I/O logic signal of the chip; and
an off-chip model, configured to construct one or more orders of RLCG (resistor-inductor-capacitor-conductor) circuit cascading models in accordance with all or part of the off-chip model abstracted by a S parameter;
wherein the application program and the RLCG circuit cascading model are integrated for simulating and analyzing power integrity and signal integrity of the simulation circuit.

2. The simulation system as claimed in claim 1, wherein the off-chip model is configured to construct one or more orders of RLCG circuit cascading models, comprising:
searching for at least one resonant frequency in accordance with all or part of the off-chip model abstracted by the S parameter;
adjusting values of a capacitor and a inductor corresponding to at least one circuit model in accordance with the at least one resonant frequency, so that an impedance difference between each of the at least one circuit model in the one or more orders of RLCG circuit cascading models and all or part of the off-chip model abstracted by the S parameter is at a minimum at a corresponding resonant frequency.

3. The simulation system as claimed in claim 1, wherein the off-chip model is configured to construct one or more orders of RLCG circuit cascading models, further comprising:
adjusting the values of the resistor and the conductor corresponding to at least one circuit model in accordance with at least two resonant frequencies, so that an impedance difference between each of the at least one circuit model in the one or more orders of RLCG circuit cascading models and all or part of the off-chip model abstracted by the S parameter is at a minimum between two corresponding adjacent resonant frequencies.

4. The simulation system as claimed in claim 1, wherein the application program and the RLCG circuit cascading model are integrated, comprising:
compiling the RLCG cascading model from SystemC-AMS to a first code; compiling the chip model from SystemC to a second code; cascading the first code and the second code and inputting a signal generated by the application program; and after calculating, the RLCG circuit cascading model can receive the power consumption and the I/O logic signal generated by the simulation system.

5. The simulation system as claimed in claim 1, wherein the power consumption of the chip generated by the chip model is used for analyzing power integrity, and the I/O logic signal of the chip is used for analyzing signal integrity.

6. The simulation system as claimed in claim 1, wherein the off-chip model is configured to construct one or more orders of RLCG circuit cascading models for abstracting all or part of the off-chip model to replace the S parameter.

7. The simulation system as claimed in claim 1, wherein the application program, the instruction set, the chip model, and the off-chip model can be accomplished using high-level languages.

8. A simulation method, implementing an application program to generate a corresponding instruction set in accordance with an application situation of a simulation circuit, wherein the simulation circuit comprises a chip, comprising:
generating a chip model configured to receive the instruction set as an input to simulate operation of at least one intellectual property core of the chip via high-level languages in accordance with the at least one intellectual property core of the chip and to generate a power consumption and an I/O logic signal of the chip;
generating an off-chip model configured to construct one or more orders of RLCG (resistor-inductor-capacitor-conductor) circuit cascading models in accordance with all or part of the off-chip model abstracted by a S parameter; and
integrating the application program and the RLCG circuit cascading model for simulating and analyzing power integrity and signal integrity of the simulation circuit.

9. The simulation method as claimed in claim 8, wherein the off-chip model is configured to construct one or more orders of RLCG circuit cascading models, comprising:
searching for at least one resonant frequency in accordance with all or part of the off-chip model abstracted by the S parameter;
adjusting the values of a capacitor and a inductor corresponding to at least one circuit model in accordance with the at least one resonant frequency, so that an impedance difference between each of the at least one circuit model in the one or more orders of RLCG circuit cascading models and all or part of the off-chip model abstracted by the S parameter is at a minimum at a corresponding resonant frequency.

10. The simulation method as claimed in claim 8, wherein the off-chip model is configured to construct one or more orders of RLCG circuit cascading models, further comprising:
adjusting the values of a resistor and a conductor corresponding to at least one circuit model in accordance with at least two resonant frequencies, so that an impedance difference between each of the at least one circuit model in the one or more orders of RLCG circuit cascading models and all or part of the off-chip model abstracted by the S parameter is at a minimum between two corresponding adjacent resonant frequencies.

11. The simulation method as claimed in claim 8, wherein the application program and the RLCG circuit cascading model are integrated, comprising:
compiling the RLCG cascading model from SystemC-AMS to a first code; compiling the chip model from SystemC to a second code; cascading the first code and the second code and inputting a signal generated by the application program; and after calculating, the RLCG circuit cascading model can receive the power consumption and the I/O logic signal generated by the simulation system.

12. The simulation method as claimed in claim 8, wherein the power consumption of the chip generated by the chip model is used for analyzing power integrity, and the I/O logic signal of the chip is used for analyzing signal integrity.

13. The simulation method as claimed in claim 8, wherein the off-chip model is configured to construct one or more orders of RLCG circuit cascading models for abstracting all or part of the off-chip model to replace the S parameter.

14. The simulation method as claimed in claim 8, wherein the application program, the instruction set, the chip model, and the off-chip model can be accomplished using high-level languages.
